(19) United States
(12) Patent Application Publication
(10) Pub. No.: US 2026/0113422 A1
(43) Pub. Date: Apr. 23, 2026

(54) Color Decorrelation In Video And Image Compression

(71) Applicant: Google LLC, Mountain View, CA (US)

(72) Inventors: Xiang Li, Saratoga, CA (US); Yaowu Xu, Saratoga, CA (US); Jingning Han, Santa Clara, CA (US)

(21) Appl. No.: 19/120,471

(22) PCT Filed: Dec. 19, 2022
(86) PCT No.: PCT/US2022/053372

§ 371 Date: Apr. 11, 2025

Related U.S. Application Data
(60) Provisional application No. 63/415,948, filed on Oct. 13, 2022.

(51) Int. Cl. H04N 9/67; H04N 19/124; H04N 19/159; H04N 19/176; H04N 19/82

(52) U.S. Cl. CPC H04N 9/67; H04N 19/124; H04N 19/159; H04N 19/176; H04N 19/82

(57) ABSTRACT

Image and video compression using color decorrelation is described. A method described herein includes receiving color transform information for an encoded block of image data, wherein the color transform information identifies an adaptive transform matrix used to convert an original block of the image data from an original color space to a new color space, thereby resulting in color decorrelation of the original block. A decoder receives a compressed bitstream including the encoded block that was encoded using the new color space and reconstructs the block from the encoded block. The method includes determining, from the color transform information, the adaptive transform matrix. After reconstructing the block, an inverse color transform of the block is performed using the matrix to obtain pixel values for a reconstructed block corresponding to the original block in the original color space, and the image data including the reconstructed block is stored or transmitted.

### BACKGROUND

Digital video streams may represent video using a sequence of frames or still images. Digital video can be used for various applications including, for example, video conferencing, high-definition video entertainment, video advertisements, or sharing of user-generated videos. A digital video stream can contain a large amount of data and consume a significant amount of computing or communication resources of a computing device for processing, transmission, or storage of the video data. Various approaches have been proposed to reduce the amount of data in video streams, including compression and other coding techniques. These techniques may include both lossy and lossless coding techniques.

### SUMMARY

This disclosure relates generally to encoding and decoding image data of images and videos and more particularly relates to compression techniques using color decorrelation.

An aspect of this disclosure is a method for decoding image data. The method can include receiving color transform information for an encoded block of the image data, wherein the color transform information identifies an adaptive transform matrix used to convert an original block of the image data from an original color space to a new color space, thereby resulting in color decorrelation of the original block before producing the encoded block representing the original block, receiving, by a decoder, a compressed bitstream including the encoded block, reconstructing, by the decoder, a block from the encoded block, determining, from the color transform information, the adaptive transform matrix. after reconstructing the block, performing an inverse color transform of the block using the adaptive transform matrix to obtain pixel values for a reconstructed block in the original color space that corresponds to the original block, and storing or displaying the image data including the reconstructed block.

Another aspect of this disclosure is a method for encoding an image. The method can include applying, to an original block of the image, an adaptive transform matrix that converts pixel values of the original block from an original color space to a new color space, thereby resulting in color decorrelation of the original block; encoding, by an encoder, a residual block of transform coefficients generated using the new color space into a compressed bitstream, thereby producing an encoded block representing the original block, transmitting, to a receiving station including a decoder, color transform information for the encoded block, wherein the color transform information identifies the adaptive transform matrix, and transmitting, to the receiving station, the compressed bitstream including the encoded block.

Apparatuses to perform each of the methods are also described.

It will be appreciated that aspects can be implemented in any convenient form. For example, aspects may be implemented by appropriate computer programs which may be carried on appropriate carrier media which may be tangible carrier media (e.g., disks) or intangible carrier media (e.g., communications signals). Aspects may also be implemented using suitable apparatus which may take the form of programmable computers running computer programs arranged to implement the methods and/or techniques disclosed herein. Aspects can be combined such that features described in the context of one aspect may be implemented in another aspect.

These and other aspects of the present disclosure are disclosed in the following detailed description of the embodiments, the appended claims, and the accompanying figures.

### BRIEF DESCRIPTION OF THE DRAWINGS

The description herein refers to the accompanying drawings described below wherein like reference numerals refer to like parts throughout the several views.

FIG. 1 is a schematic of a video encoding and decoding system.

FIG. 2 is a block diagram of an example of a computing device that can implement a transmitting station or a receiving station.

FIG. 3 is a diagram of an example of a video stream to be encoded and subsequently decoded.

FIG. 4 is a block diagram of an encoder.

FIG. 5 is a block diagram of a decoder.

FIG. 6 is a block diagram of another implementation of a decoder.

FIG. 7 is a diagram used to explain a cross-component linear model prediction mode that may be used with color decorrelation according to the teachings herein.

FIG. 8 is a flowchart of a method for decoding image data using color decorrelation according to the teachings herein.

FIG. 9A is a block diagram of an apparatus using color decorrelation according to the teachings herein.

FIG. 9B is a block diagram of another apparatus using color decorrelation according to the teachings herein.

FIG. 10 is a block diagram of an apparatus for encoding image data using color decorrelation according to the teachings herein.

FIG. 11 is a block diagram of an apparatus for decoding image data using color decorrelation according to the teachings herein.

### DETAILED DESCRIPTION

As mentioned, compression schemes related to coding video streams may include breaking images into blocks and generating a digital video output bitstream (i.e., an encoded bitstream) using one or more techniques to limit the information included in the output bitstream. A received bitstream can be decoded to re-create the blocks and the source images from the limited information. Encoding a video stream, or a portion thereof, such as a frame or a block, can include using temporal or spatial similarities in the video stream to improve coding efficiency. For example, a current block of a video stream may be encoded based on identifying a difference (residual) between previously coded pixel values, or between a combination of previously coded pixel values, and those in the current block.

In general, the blocks of an image or frame are represented by three planes of data, each corresponding to a color component of a color space. For example, the color space may be the red-green-blue (RGB) color space, and the three planes of data are a plane representing pixel values of the red image data (i.e., a red data plane), a plane representing pixel values of the green image data (i.e., a green data plane), and a plane representing pixel values of the blue image data (i.e., a blue data plane). In another example, the color space may be one of a family of color spaces including a luminance (or luma) component Y or Y′ represented by a first plane of pixel values and two chrominance (or chroma) components, e.g., the blue-difference chroma component Cb or U and the red-difference chroma component Cb or V, represented by second and third planes of pixel values, respectively. The color space may be referred to as a YCbCbr, Y′CbCbr, or YUV. For simplicity of explanation, the examples herein may refer to only one luma-chroma color space, but the teachings apply equally to the other luma-chroma color spaces.

In the compression schemes referred to previously, the planes of color data are separately compressed for encoding and for transmission to a decoder for decoding and reconstruction. The planes of color data may exhibit a strong correlation among the different components. Some codecs (i.e., encoder-decoder combinations) may take advantage of this correlation by selecting compression techniques for one or more planes of data based on compression techniques used for another plane of data. In general, however, the correlation can lead to a reduced compression efficiency as compared to situations where the data is not correlated.

The techniques described herein use color decorrelation in video and image compression to improve compression efficiency. Details of the techniques are described herein with initial reference to a system in which it can be implemented.

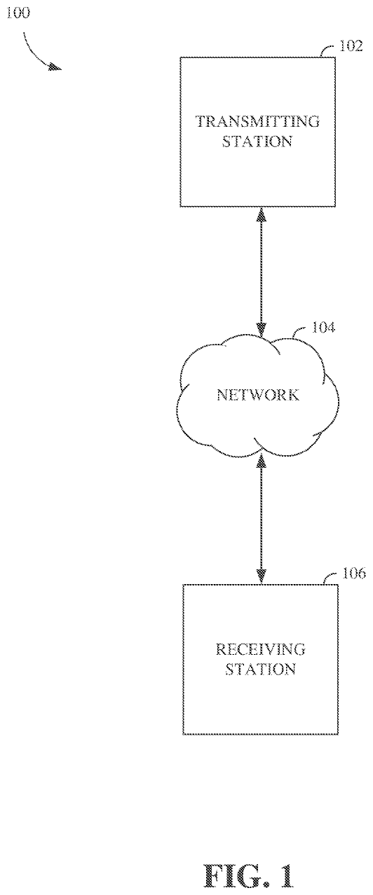

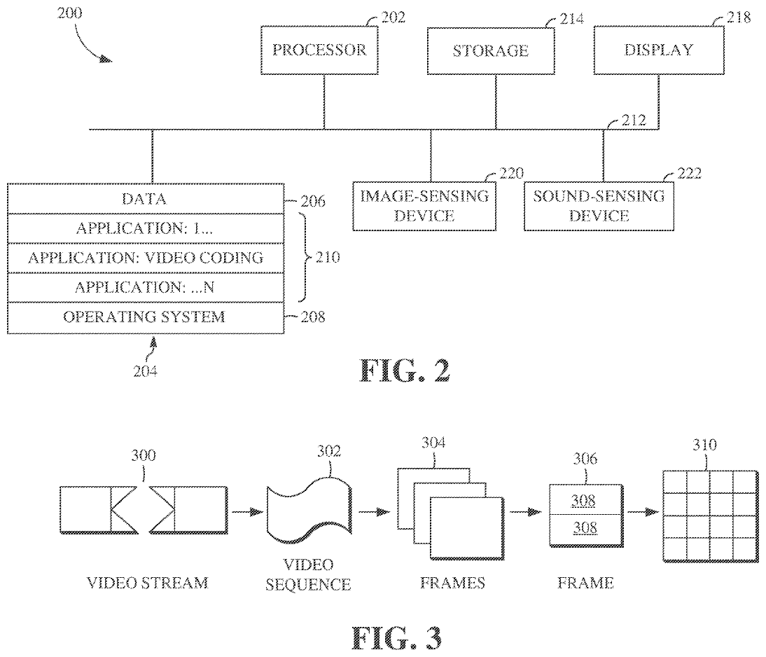

FIG. 1 is a schematic of a video encoding and decoding system 100. A transmitting station 102 can be, for example, a computer having an internal configuration of hardware such as that described in FIG. 2. However, other suitable implementations of the transmitting station 102 are possible. For example, the processing of the transmitting station 102 can be distributed among multiple devices.

A network 104 can connect the transmitting station 102 and a receiving station 106 for encoding and decoding of the video stream. Specifically, the video stream can be encoded in the transmitting station 102 and the encoded video stream can be decoded in the receiving station 106. The network 104 can be, for example, the Internet. The network 104 can also be a local area network (LAN), wide area network (WAN), virtual private network (VPN), cellular telephone network or any other means of transferring the video stream from the transmitting station 102 to, in this example, the receiving station 106.

The receiving station 106, in one example, can be a computer having an internal configuration of hardware such as that described in FIG. 2. However, other suitable implementations of the receiving station 106 are possible. For example, the processing of the receiving station 106 can be distributed among multiple devices.

Other implementations of the video encoding and decoding system 100 are possible. For example, an implementation can omit the network 104. In another implementation, a video stream can be encoded and then stored for transmission at a later time to the receiving station 106 or any other device having memory. In one implementation, the receiving station 106 receives (e.g., via the network 104, a computer bus, and/or some communication pathway) the encoded video stream and stores the video stream for later decoding. In an example implementation, a real-time transport protocol (RTP) is used for transmission of the encoded video over the network 104. In another implementation, a transport protocol other than RTP may be used, e.g., a Hypertext Transfer Protocol (HTTP) video streaming protocol.

When used in a video conferencing system, for example, the transmitting station 102 and/or the receiving station 106 may include the ability to both encode and decode a video stream as described below. For example, the receiving station 106 could be a video conference participant who receives an encoded video bitstream from a video conference server (e.g., the transmitting station 102) to decode and view and further encodes and transmits its own video bitstream to the video conference server for decoding and viewing by other participants.

FIG. 2 is a block diagram of an example of a computing device 200 (e.g., an apparatus) that can implement a transmitting station or a receiving station. For example, the computing device 200 can implement one or both of the transmitting station 102 and the receiving station 106 of FIG. 1. The computing device 200 can be in the form of a computing system including multiple computing devices, or in the form of one computing device, for example, a mobile phone, a tablet computer, a laptop computer, a notebook computer, a desktop computer, and the like.

A CPU 202 in the computing device 200 can be a conventional central processing unit. Alternatively, the CPU 202 can be any other type of device, or multiple devices, capable of manipulating or processing information now existing or hereafter developed. Although the disclosed implementations can be practiced with one processor as shown, e.g., the CPU 202, advantages in speed and efficiency can be achieved using more than one processor.

A memory 204 in computing device 200 can be a read only memory (ROM) device or a random-access memory (RAM) device in an implementation. Any other suitable type of storage device can be used as the memory 204. The memory 204 can include code and data 206 that is accessed by the CPU 202 using a bus 212. The memory 204 can further include an operating system 208 and application programs 210, the application programs 210 including at least one program that permits the CPU 202 to perform the methods described here. For example, the application programs 210 can include applications 1 through N, which further include a video coding application that performs the methods described here. Computing device 200 can also include a secondary storage 214, which can, for example, be a memory card used with a mobile computing device. Because the video communication sessions may contain a significant amount of information, they can be stored in whole or in part in the secondary storage 214 and loaded into the memory 204 as needed for processing.

The computing device 200 can also include one or more output devices, such as a display 218. The display 218 may be, in one example, a touch sensitive display that combines a display with a touch sensitive element that is operable to sense touch inputs. The display 218 can be coupled to the CPU 202 via the bus 212. Other output devices that permit a user to program or otherwise use the computing device 200 can be provided in addition to or as an alternative to the display 218. When the output device is or includes a display, the display can be implemented in various ways, including by a liquid crystal display (LCD), a cathode-ray tube (CRT) display or light emitting diode (LED) display, such as an organic LED (OLED) display.

The computing device 200 can also include or be in communication with an image-sensing device 220, for example a camera, or any other image-sensing device 220 now existing or hereafter developed that can sense an image such as the image of a user operating the computing device 200. The image-sensing device 220 can be positioned such that it is directed toward the user operating the computing device 200. In an example, the position and optical axis of the image-sensing device 220 can be configured such that the field of vision includes an area that is directly adjacent to the display 218 and from which the display 218 is visible.

The computing device 200 can also include or be in communication with a sound-sensing device 222, for example a microphone, or any other sound-sensing device now existing or hereafter developed that can sense sounds near the computing device 200. The sound-sensing device 222 can be positioned such that it is directed toward the user operating the computing device 200 and can be configured to receive sounds, for example, speech or other utterances, made by the user while the user operates the computing device 200.

Although FIG. 2 depicts the CPU 202 and the memory 204 of the computing device 200 as being integrated into one unit, other configurations can be utilized. The operations of the CPU 202 can be distributed across multiple machines (wherein individual machines can have one or more of processors) that can be coupled directly or across a local area or other network. The memory 204 can be distributed across multiple machines such as a network-based memory or memory in multiple machines performing the operations of the computing device 200. Although depicted here as one bus, the bus 212 of the computing device 200 can be composed of multiple buses. Further, the secondary storage 214 can be directly coupled to the other components of the computing device 200 or can be accessed via a network and can comprise an integrated unit such as a memory card or multiple units such as multiple memory cards. The computing device 200 can thus be implemented in a wide variety of configurations.

FIG. 3 is a diagram of an example of a video stream 300 to be encoded and subsequently decoded. The video stream 300 includes a video sequence 302. At the next level, the video sequence 302 includes a number of adjacent frames 304. While three frames are depicted as the adjacent frames 304, the video sequence 302 can include any number of adjacent frames 304. The adjacent frames 304 can then be further subdivided into individual frames, e.g., a frame 306. At the next level, the frame 306 can be divided into a series of planes or segments 308. The segments 308 can be subsets of frames that permit parallel processing, for example. The segments 308 can also be subsets of frames that can separate the video data into separate colors. For example, a frame 306 of color video data can include a luminance plane and two chrominance planes. The segments 308 may be sampled at different resolutions.

Whether or not the frame 306 is divided into segments 308, the frame 306 may be further subdivided into blocks 310, which can contain data corresponding to, for example, 16×16 pixels in the frame 306. The blocks 310 can also be arranged to include data from one or more segments 308 of pixel data. The blocks 310 can also be of any other suitable size such as 4×4 pixels, 8×8 pixels, 16×8 pixels, 8×16 pixels, 16×16 pixels, or larger. Unless otherwise noted, the terms block and macro-block are used interchangeably herein.

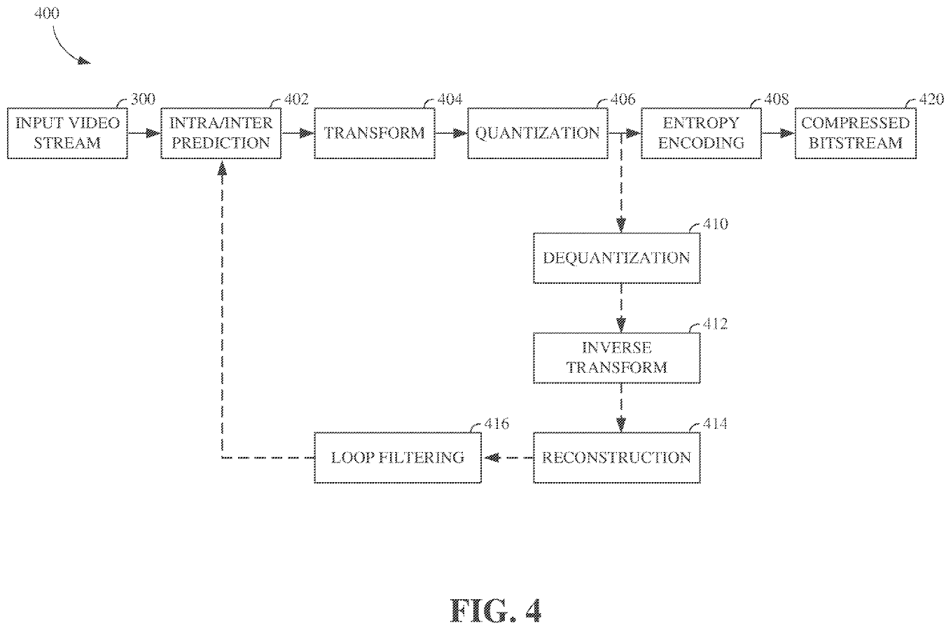

FIG. 4 is a block diagram of an encoder 400. The encoder 400 can be implemented, as described above, in the transmitting station 102 such as by providing a computer software program stored in memory, for example, the memory 204. The computer software program can include machine instructions that, when executed by a processor such as the CPU 202, cause the transmitting station 102 to encode video data in the manner described in FIG. 4. The encoder 400 can also be implemented as specialized hardware included in, for example, the transmitting station 102. In one particularly desirable implementation, the encoder 400 is a hardware encoder.

The encoder 400 has the following stages to perform the various functions in a forward path (shown by the solid connection lines) to produce an encoded or compressed bitstream 420 using the video stream 300 as input: an intra/inter prediction stage 402, a transform stage 404, a quantization stage 406, and an entropy encoding stage 408. The encoder 400 may also include a reconstruction path (shown by the dotted connection lines) to reconstruct a frame for encoding of future blocks. In FIG. 4, the encoder 400 has the following stages to perform the various functions in the reconstruction path: a dequantization stage 410, an inverse transform stage 412, a reconstruction stage 414, and a loop filtering stage 416. Other structural variations of the encoder 400 can be used to encode the video stream 300.

When the video stream 300 is presented for encoding, respective frames 304, such as the frame 306, can be processed in units of blocks. At the intra/inter prediction stage 402, respective blocks can be encoded using intra-frame prediction (also called intra-prediction) or inter-frame prediction (also called inter-prediction). In any case, a prediction block can be formed. In the case of intra-prediction, a prediction block may be formed from samples in the current frame that have been previously encoded and reconstructed. In the case of inter-prediction, a prediction block may be formed from samples in one or more previously constructed reference frames.

Next, still referring to FIG. 4, the prediction block can be subtracted from the current block at the intra/inter prediction stage 402 to produce a residual block (also called a residual). The transform stage 404 transforms the residual into transform coefficients in, for example, the frequency domain using block-based transforms. The quantization stage 406 converts the transform coefficients into discrete quantum values, which are referred to as quantized transform coefficients, using a quantizer value or a quantization level. For example, the transform coefficients may be divided by the quantizer value and truncated. The quantized transform coefficients are then entropy encoded by the entropy encoding stage 408. The entropy-encoded coefficients, together with other information used to decode the block, which may include for example the type of prediction used, transform type, motion vectors and quantizer value, are then output to the compressed bitstream 420. The compressed bitstream 420 can be formatted using various techniques, such as variable length coding (VLC) or arithmetic coding. The compressed bitstream 420 can also be referred to as an encoded video stream or encoded video bitstream, and the terms will be used interchangeably herein.

The reconstruction path in FIG. 4 (shown by the dotted connection lines) can be used to ensure that the encoder 400 and a decoder 500 (described below) use the same reference frames to decode the compressed bitstream 420. The reconstruction path performs functions that are similar to functions that take place during the decoding process that are discussed in more detail below, including dequantizing the quantized transform coefficients at the dequantization stage 410 and inverse transforming the dequantized transform coefficients at the inverse transform stage 412 to produce a derivative residual block (also called a derivative residual). At the reconstruction stage 414, the prediction block that was predicted at the intra/inter prediction stage 402 can be added to the derivative residual to create a reconstructed block. The loop filtering stage 416 can be applied to the reconstructed block to reduce distortion such as blocking artifacts.

Other variations of the encoder 400 can be used to encode the compressed bitstream 420. For example, a non-transform-based encoder can quantize the residual signal directly without the transform stage 404 for certain blocks or frames. In another implementation, an encoder can have the quantization stage 406 and the dequantization stage 410 combined in a common stage.

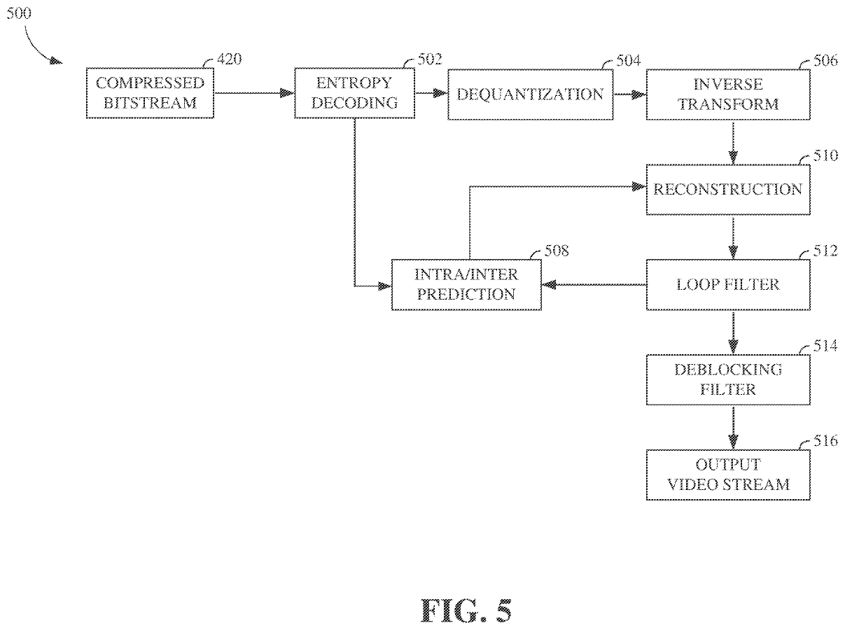

FIG. 5 is a block diagram of a decoder 500. The decoder 500 can be implemented in the receiving station 106, for example, by providing a computer software program stored in the memory 204. The computer software program can include machine instructions that, when executed by a processor such as the CPU 202, cause the receiving station 106 to decode video data in the manner described in FIG. 5. The decoder 500 can also be implemented in hardware included in, for example, the transmitting station 102 or the receiving station 106.

The decoder 500, similar to the reconstruction path of the encoder 400 discussed above, includes in one example the following stages to perform various functions to produce an output video stream 516 from the compressed bitstream 420: an entropy decoding stage 502, a dequantization stage 504, an inverse transform stage 506, an intra/inter prediction stage 508, a reconstruction stage 510, a loop filtering stage 512 and a deblocking filtering stage 514. Other structural variations of the decoder 500 can be used to decode the compressed bitstream 420.

When the compressed bitstream 420 is presented for decoding, the data elements within the compressed bitstream 420 can be decoded by the entropy decoding stage 502 to produce a set of quantized transform coefficients. The dequantization stage 504 dequantizes the quantized transform coefficients (e.g., by multiplying the quantized transform coefficients by the quantizer value), and the inverse transform stage 506 inverse transforms the dequantized transform coefficients to produce a derivative residual that can be identical to that created by the inverse transform stage 412 in the encoder 400. Using header information decoded from the compressed bitstream 420, the decoder 500 can use the intra/inter prediction stage 508 to create the same prediction block as was created in the encoder 400, e.g., at the intra/inter prediction stage 402. At the reconstruction stage 510, the prediction block can be added to the derivative residual to create a reconstructed block. The loop filtering stage 512 can be applied to the reconstructed block to reduce blocking artifacts.

Other filtering can be applied to the reconstructed block. In this example, the deblocking filtering stage 514 is applied to the reconstructed block to reduce blocking distortion, and the result is output as the output video stream 516. The output video stream 516 can also be referred to as a decoded video stream, and the terms will be used interchangeably herein. Other variations of the decoder 500 can be used to decode the compressed bitstream 420. For example, the decoder 500 can produce the output video stream 516 without the deblocking filtering stage 514.

In video and image compression, an input signal in the RGB color space or domain is often first converted to a luma-chroma color space such as the YUV domain before being fed into a video/image codec. The conversion from RGB to YUV removes some redundancy among different color components. To further reduce the redundancy among different components, cross-component prediction and joint chroma residual coding may be used as discussed below.

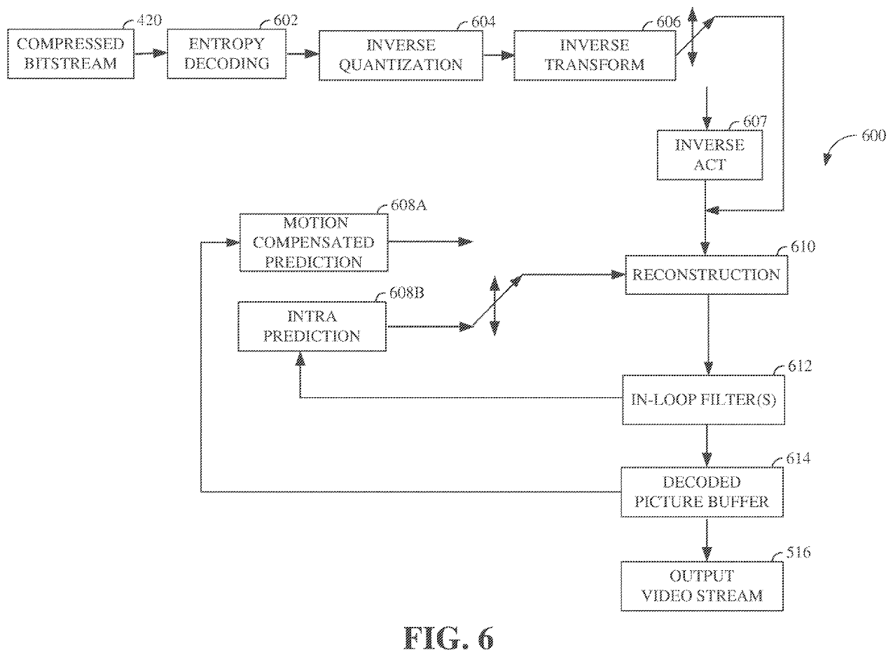

Compression efficiency may be further improved in a codec that applies an adaptive color transform (ACT) that further reduces redundancy between the color components. As mentioned above, reducing the correlation/redundancy among the components increases compression efficiency of the different planes. Applying an ACT is described with regards to FIG. 6, which is a block diagram of another implementation of a decoder 600.

The decoder 600 of FIG. 6 can be implemented in the receiving station 106, for example, by providing a computer software program stored in the memory 204. The computer software program can include machine instructions that, when executed by a processor such as the CPU 202, cause the receiving station 106 to decode video data in the manner described in FIG. 6. The decoder 600 can also be implemented in hardware included in, for example, the transmitting station 102 or the receiving station 106.

The decoder 600 includes in one example the following stages to perform various functions to produce the output video stream 516 from the compressed bitstream 420: an entropy decoding stage 602, an inverse quantization stage 604, an inverse transform stage 606, an inverse ACT stage 607, a motion compensated prediction stage 608A, an intra prediction stage 608B, a reconstruction stage 610, an in-loop filtering stage 612, and a decoded picture buffer stage 614. Other structural variations of the decoder 600 can be used to decode the compressed bitstream 420.

When the compressed bitstream 420 is presented for decoding, the data elements within the compressed bitstream 420 can be decoded by the entropy decoding stage 602 to produce a set of quantized transform coefficients. Like the dequantization stage 504 of the decoder 500, the inverse quantization stage 604 dequantizes the quantized transform coefficients (e.g., by multiplying the quantized transform coefficients by the quantizer value). For this reason, the inverse quantization stage 606 may also be referred to as a dequantization stage. The inverse transform stage 606 receives the dequantized transform coefficients and inverse transforms the dequantized transform coefficients to produce a derivative residual that can be identical to that created by a corresponding inverse transform stage, such as the inverse transform stage 412 described with respect to the encoder 400.

Although not shown in FIG. 6 for clarity, the entropy decoding stage 602 can provide similar data to the motion compensated prediction stage 608A and the intra prediction stage 608B as the data the entropy decoding stage 502 provides to the intra/inter prediction stage 508. For example, using header information decoded from the compressed bitstream 420, the decoder 600 can use the motion compensated prediction stage 608A or the intra prediction stage 608B to create the same prediction block as was created in the corresponding stage of an encoder. The motion compensated prediction stage 608A may also be referred to as an inter prediction stage. Moreover, and while shown separately in the decoder 600, the motion compensated prediction stage 608A and the intra prediction stage 608B may be combined like the intra/inter prediction stage 508.

At the reconstruction stage 610, the prediction block can be added to the derivative residual to create a reconstructed block. The in-loop filtering stage 612 applies one or more in-loop filters to the reconstructed blocks to reduce artifacts, such as blocking artifacts, in a like manner as the loop filtering stage 512 and/or the deblocking filtering stage 514.

The reconstructed and filtered blocks output from the in-loop filtering stage 612 are available as reference blocks for the intra prediction stage 608B and, together with other reconstructed blocks of the current frame, form a reference frame that may be stored in the decoded picture buffer stage 614 for use in the motion compensated prediction stage 608A. In any event the current reconstructed frame forms part of the output video stream 516. The output video stream 516 can also be referred to as a decoded video stream, and the terms will be used interchangeably herein. Other variations of the decoder 600 can be used to decode the compressed bitstream 420. For example, the decoder 600 can produce the output video stream 516 without the in-loop filtering stage 612 and/or additional post-loop filtering may be performed.

Some decoded residual blocks from the inverse transform stage 606 are provided to an inverse ACT stage 607. In brief, in a corresponding encoder the adaptive color transform (ACT) performs block level in-loop color space conversion in the prediction residual domain by adaptively converting the residuals from the input color space to a luma-chroma color space and particularly to a luma value Y and two chroma values referred to as chrominance green Cg and chrominance orange Co (i.e., a YCgCo space) described in additional detail below before transformation and quantization. In the inverse ACT stage 607, the process is reversed to reconstruct the prediction residual into the input color space.

To implement the ACT, the encoder can signal the selection of one color space of two color spaces, e.g., using a flag in a header at a coding unit CU level (or at a block level). The adaptive selection of the color space for compression may be done at the encoder by any technique. For example, use of the ACT may be available (enabled, permissible, etc.) for only certain blocks. In an implementation where a block is predicted using inter prediction (i.e., an inter block or CU) or is predicted using Intra Block Copy (IBC) mode, the ACT may be enabled only when there is at least one non-zero coefficient in the block. In an implementation where a block is predicted using intra prediction, (i.e., an intra block or CU), the ACT may be enabled only when chroma components of the block select the same intra-prediction mode as the luma component of the block, e.g., the Direct Mode (DM). For blocks where the ACT is enabled, coding the residuals of the block may performed in the original color space and in the YCgCo space, and the encoded blocks may be compared to select which mode results in the best compression. The best compression may be, for example, the one that results in the fewest bits, the least distortion, or some combination thereof. In some implementations, the encoder may decide whether to use the ACT by whichever encoded block provides the lowest rate-distortion (RD) value.

As mentioned, the encoder can signal the adaptive selection of the ACT by signaling an ACT flag at the block or CU level. In an example, when the flag is equal to one the residuals of the block are coded in the YCgCo space. Otherwise, the residuals of the block are coded in the original color space. The decoder 600 can decode the ACT flag from the compressed bitstream 420 to maintain the reconstruction path described above or to provide the residual block (e.g., the dequantized transform coefficients) from the inverse transform stage 606 to the inverse ACT stage 607 to apply the ACT before proceeding to the reconstruction stage 610.

The ACT may be a YCgCo-R reversible color transform that can support both lossy and lossless coding. That is, for example, the ACT may be used in a codec without quantization such that the decoder 600 omits the inverse quantization stage 604 and the corresponding encoder omits a quantization stage, such as the quantization stage 406.

The ACT applied at the encoder may include a forward conversion of pixel values from an original green G-blue B-red R (GBR) color space to the YCgCo space accordingly to:

$$Co = R - B ;$$

$$t = B + ( Co ≫ 1 ) ;$$

$$Cg = G - t ; and$$

$$Y = t + ( Cg ≫ 1 ) .$$

The ACT applied at the inverse ACT stage 607 may include a backward conversion of pixel values from the YC Co space to the GBR color space according to:

$$t = Y - ( Cg ≫ 1 ) ;$$

$$G = Cg + t ;$$

$$B = t - ( Co ≫ 1 ) ; and$$

$$R = Co + B .$$

The YCgCo-R transforms are not normalized in this example. To compensate for the dynamic range change of residuals signals before and after color transformation, quantization parameter (QP) adjustments of (−5, 1, 3) may be applied to the transform residuals of the Y, Cg, and Co components, respectively. The adjusted QP only affects the quantization and inverse quantization of the residuals in the block. For other coding processes (such as deblocking), the original QP value per plane is still used.

It is worth noting that, because the forward and inverse color transforms access the residuals of all three components, the ACT mode may be disabled where a prediction block size of different color components is different due to, e.g., the partition mode used to partition a coding unit. Application of the ACT may be limited to reducing the redundancy between three color components in 4:4:4 chroma format (i.e., where the chroma components are not subsampled).

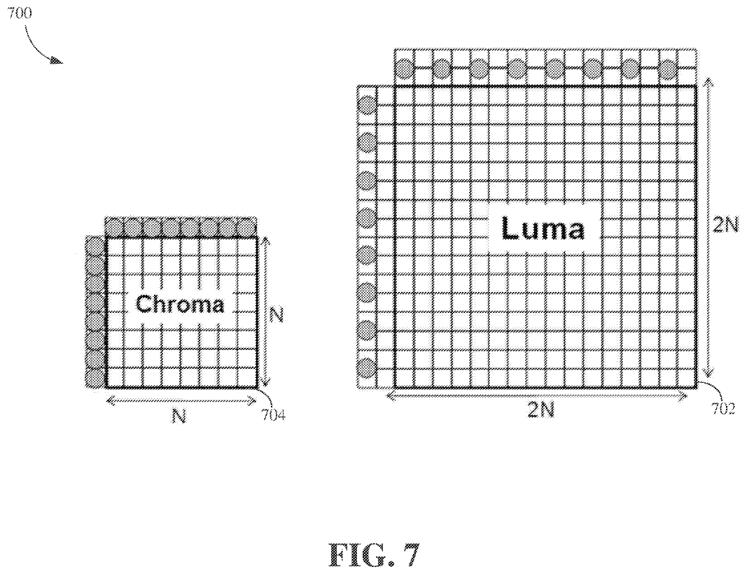

FIG. 7 is a diagram used to explain a cross-component linear model (CCLM) prediction mode that may be used with color decorrelation according to the teachings herein. The CCLM prediction mode may further reduce the redundancy among the different components by predicting chroma samples based on reconstructed luma samples of the same block 700. In FIG. 7, the luma block 702 to the right comprises 2N×2N luma pixels and the chroma blocks (one chroma block 704 shown to the left) each comprise N×N chroma pixels. FIG. 7 represents chroma subsampling, which compresses image data by reducing the color (chrominance) information in favor of the luminance data. In particular, FIG. 7 may represent 4:2:0 chroma subsampling where the sample size of the luma samples is 4, the value 2 represents the horizontal sampling of the chroma pixels, and the value 0 represents the vertical sampling of the chroma pixels. That is, 4:2:0 chroma subsampling samples colors from half of the pixels on the first row of a chroma block and ignores the second row completely, resulting in only a quarter of the original color information as compared to an unsampled 4:4:4 signal. FIG. 7 may alternatively represent 4:2:2 chroma subsampling, which samples colors from half of the pixels on the first row of a chroma block and maintains full sampling vertically, resulting in half of the original color information as compared to an unsampled 4:4:4 signal. Other chroma subsampling may be used in the CCLM prediction mode. An unsampled 4:4:4 signal may be used in some implementations.

As mentioned, the CCLM prediction mode predicts chroma samples based the reconstructed luma samples of the same block by using a linear model in accordance with the following equation.

$$pred\_C ( i , j ) = α \cdot {rec\_L}^{′} ( i , j ) + β$$

In this equation, pred_C (i,j) represents the predicted chroma samples in a block, and rec_L′(i,j) represents (e.g., down-sampled) reconstructed luma samples of the same block. The down-sampling, where applicable, aligns the resolution of luma and chroma blocks.

The CCLM parameter a and the CCLM parameter R may be derived with at most four neighboring chroma samples and their corresponding down-sampled luma samples. FIG. 7 shows an example of the location of the left and above samples and the sample of the current block involved in the CCLM prediction mode. More specifically, neighboring chroma samples are shaded pixels adjacent to the block 704 and their corresponding down-sampled luma samples are the shaded pixels adjacent to the block 702. A division operation to calculate the CCLM parameter a may be implemented with a look-up table. The neighboring samples are predicated on the scan order for coding blocks of image data from an image or frame comprising a raster scan order. Other neighboring pixels may be used when other than a raster scan order is used.

In CCLM, to match the chroma sample locations for 4:2:0 video sequences, two types of down-sampling filters may be applied to luma samples to achieve a 2:1 down-sampling ratio in both horizontal and vertical directions. The selection of down-sampling filters may be specified by a flag, such as a sequence parameter set (SPS) level flag.

Even where CCLM is used for prediction, redundancy may still exist between chroma residuals. Whether CCLM is used or not, chroma residual redundancy may be reduced by joint coding of chroma residual (JCCR). In this example, the color space is YCbCr. A transform unit-level flag tu_joint_cbcr_residual_flag indicates the usage (activation) of the JCCR mode, and the selected mode may be implicitly indicated by the chroma coded block flags (CBFs). A CBF indicates whether a transform block of a prediction block includes any nonzero levels. As can be seen from Table 1 below, the flag tu_joint_cbcr_residual_flag is present if either or both chroma CBFs for a transform unit are equal to 1. The JCCR mode has 3 sub-modes. When the JCCR mode is activated, one single joint chroma residual block (resJointC[x][y]) instead of two is signaled so that saving in bits is obtained. The residual block for Cb (resCb) and residual block for Cr (resCr) are derived considering information such as tu_cbf_cb, tu_cbf_cr, and sign value (CSign) specified in. e.g., a corresponding slice header.

TABLE 1

| tu_cbf_cb | tu_cbf_cr | reconstruction of Cb and Cr residuals | Mode |
|---|---|---|---|
| 1 | 0 | resCb[ x ][ y ] = resJointC[ x ][ y ] | 1 |
| | | resCr[ x ][ y ] = ( CSign * resJointC[ x ][ y ] ) >> 1 | |
| 1 | 1 | resCb[ x ][ y ] = resJointC[ x ][ y ] | 2 |
| | | resCr[ x ][ y ] = CSign * resJointC[ x ][ y ] | |
| 0 | 1 | resCb[ x ][ y ] = ( CSign * resJointC[ x ][ y ] ) >> 1 | 3 |
| | | resCr[ x ][ y ] = resJointC[ x ][ y ] | |

While these techniques attempt to reduce the effects of correlation among the different color components, they are not entirely successful. In part, this is due to the use of the fixed color transform of the ACT. Accordingly, it cannot adapt to a signal efficiently. Strong correlation among the different color (e.g., YUV) components can still result. The correlation leads to less compression efficiency. The teachings herein describe color decorrelation in video and image compression with a higher compression efficiency. A color transform with adaptive transform matrices reduces the correlation among different color components at picture (image or video frame) level or block level. The color transform is applied at the encoder before prediction, i.e., directly on the input signal. The color transform information (such as the transform matrix) is signaled and may be used by one or more images or frame. One or more sets of color transform information may be signaled as described below.

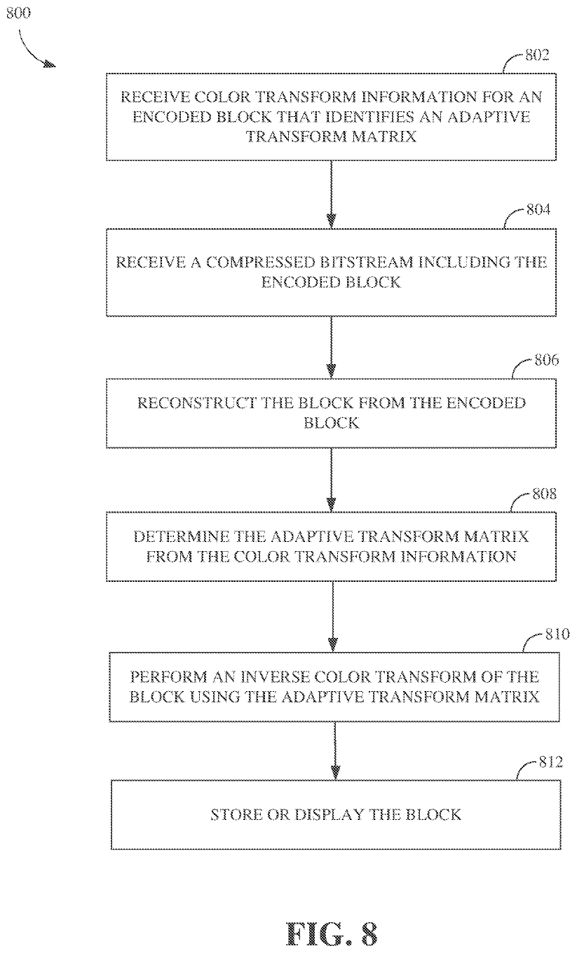

FIG. 8 is an example of a flowchart of a technique or method 800 for decoding image data. The image data may be from a single image or may be from a frame of a sequence of frames (e.g., a video sequence). The method 800 can be implemented, for example, as a software program that may be executed by computing devices such as transmitting station 102 or receiving station 106. The software program can include machine-readable instructions that may be stored in a memory such as the memory 204 or the secondary storage 214, and that, when executed by a processor, such as CPU 202, may cause the computing device to perform the method 800. The method 800 can be implemented using specialized hardware or firmware. Multiple processors, memories, or both, may be used.

At 802, color transform information for an encoded block of the image data is received. The color transform information may be received by a decoder directly, such as by a decoder 500 or a decoder 600, or the color transform information may be received by a receiving station that includes a decoder, such as the receiving station 106. The color transform information identifies an adaptive transform matrix used to convert a block of the image data from an original color space to a new color space, thereby resulting in color decorrelation of the block before producing the encoded block corresponding to the block (e.g., by compression at the encoder).

The color transform information is, in some implementations, an index to a list comprising a number of candidate transform matrices. That is, receiving the color transform information at 802 can include receiving an index identifying the adaptive transform matrix from a number of candidate transform matrices. The candidate transform matrices may be pre-defined matrices available to each of an encoder and the receiving station, the decoder, or both. In some implementations, the candidate transform matrices may be signaled between them. The color transform information may be or include a precision of the matrix coefficients of the adaptive transform matrix. The precision comprises a maximum bit depth of the matrix coefficients, normalization information for determining the matrix coefficients, or both. The precision may be signaled at different levels that better adapt to the input signal (e.g., further support the color decorrelation of the input signal at the encoder). In some implementations, the precision may be predefined.

Further details of the color transform information and the adaptive transform matrix are described in additional detail below with respect to an example of a transmitting station and encoder that implement the teachings herein.

At 804, the decoder receives a compressed bitstream including the encoded block that was encoded in the new color space. The encoded block may be a compressed residual block of transform coefficients, that may also be quantized. The encoded block may thus comprise three layers of color data, such as a luma plane of pixel data and two chroma planes of pixel data.

At 806, the decoder reconstructs the block from the encoded block. As described previously, reconstructing the block may include decoding a residual block of transform coefficients from the compressed bitstream, generating a prediction block corresponding to the residual block, and combining the residual block with the prediction block. Where the transform coefficients are quantized, reconstructing the block may also include inverse or reverse quantization of the transform coefficients. The prediction block is also generated in the new color space, so the reconstructed block is in the new color space.

At 808, the adaptive transform matrix is determined from the color transform information. For example, where the color transform information is an index as described above, the index is used to identify which of the candidate transform matrices is the adaptive transform matrix for the block. In some implementations, the color transform information may include some or all matrix coefficients of the adaptive transform matrix as discussed in more detail below.

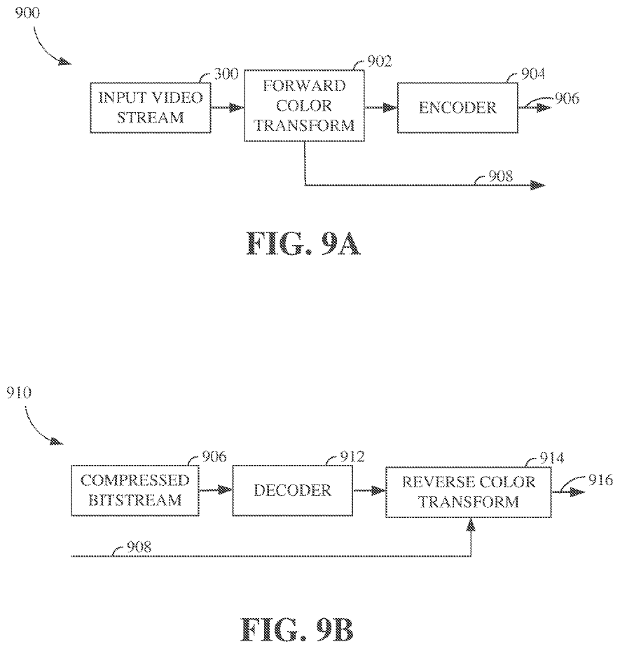

At 810, an inverse color transform of the block using the adaptive transform matrix is performed. The inverse color transform may also be referred to interchangeably as a reverse color transform herein. According to the teachings herein, the adaptive transform matrix can be used inside a video or image codec or be used for pre-processing or post-processing. This is illustrated first with reference to FIGS. 9A and 9B.

FIG. 9A is a block diagram of an apparatus 900 using color decorrelation according to the teachings herein, and FIG. 9B is a block diagram of another apparatus 910 using color decorrelation according to the teachings herein. Each illustrates an implementation when the adaptive transform matrix is not used inside a video or image codec. The apparatus 900 may be, for example, a transmitting station such as the transmitting station 102. The apparatus 910 may be, for example, a receiving station such as the receiving station 106.

The apparatus 900 receives input image data, in this example a frame of the input video stream 300 described previously. A forward color transform 902, or simply a color transform, is performed in a pre-processing step. More specifically, performing the forward color transform 902 includes applying the adaptive transform matrix described hereinbelow to block(s) of the image data to convert the blocks from an original color space to a new color space. The blocks then proceed to an encoder 904, such as the encoder 400 or an encoder corresponding to the decoder 600 (i.e., one in which an ACT is selectively applied to residuals). The encoder 904 may be any encoder for image or video compression that would benefit from color decorrelation. The output of the encoder 904 is a compressed bitstream 906 that may be stored or transmitted to a decoder. Similarly, the color transform information 908 may be stored or transmitted to a decoder from the forward color transform 902. The color transform information may be sent as side information. In an example, the apparatus 900 (e.g., the forward color transform 902 of a transmitting station) transmits the color transform information in a supplemental enhancement information (SEI) message or the like.

The apparatus 910 receives a compressed bitstream, such as the compressed bitstream 906. A decoder 912 decodes block(s) of the image data in the second, or new, color space. The decoder 912 may be the decoder 500 or the decoder 600, or any other decoder. The output of the decoder 912 is the image data in the new color space. The apparatus 910 also receives the color transform information 908 (e.g., as side information to the compressed bitstream 906). For example, receiving the color transform information may include receiving a SEI message including the color transform information that can be used to determine the adaptive transform matrix corresponding to that used for transforming the block data from the initial, or original, color space to the new color space. An inverse or reverse color transform 914 is performed in a post-processing step. More specifically, performing the inverse color transform 914 includes applying the adaptive transform matrix described hereinbelow to block(s) of the image data to convert the blocks, after reconstructing the image, from the new color space to the original color space. The output of the inverse color transform 914 is a display image 916, for example.

Referring again to FIG. 8, the method 800, or at least some steps thereof, may be repeated for other blocks of image data. That is, the method 800 may be performed for multiple encoded blocks. At 812, the image data including the block is stored or displayed.

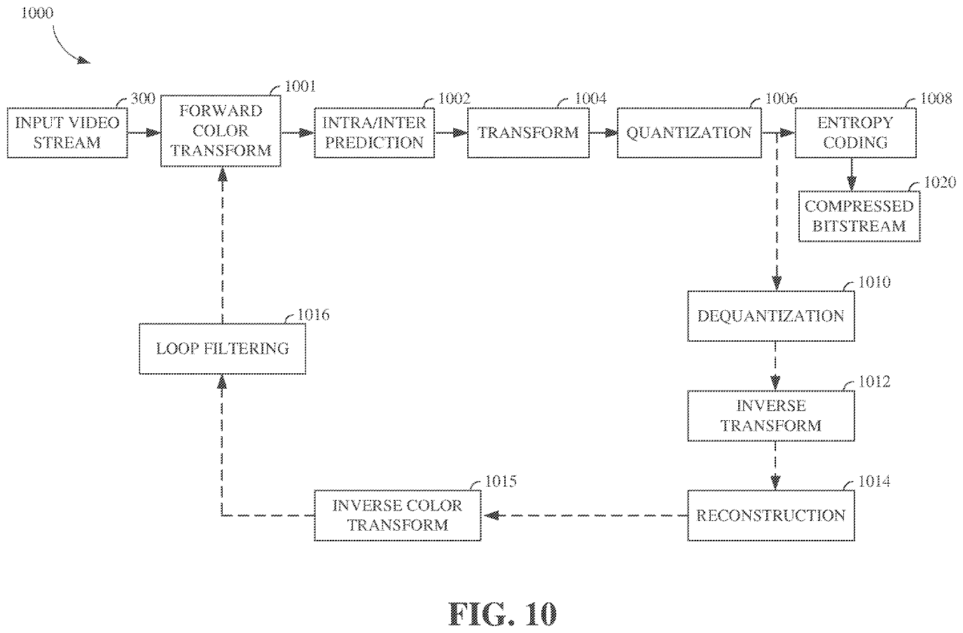

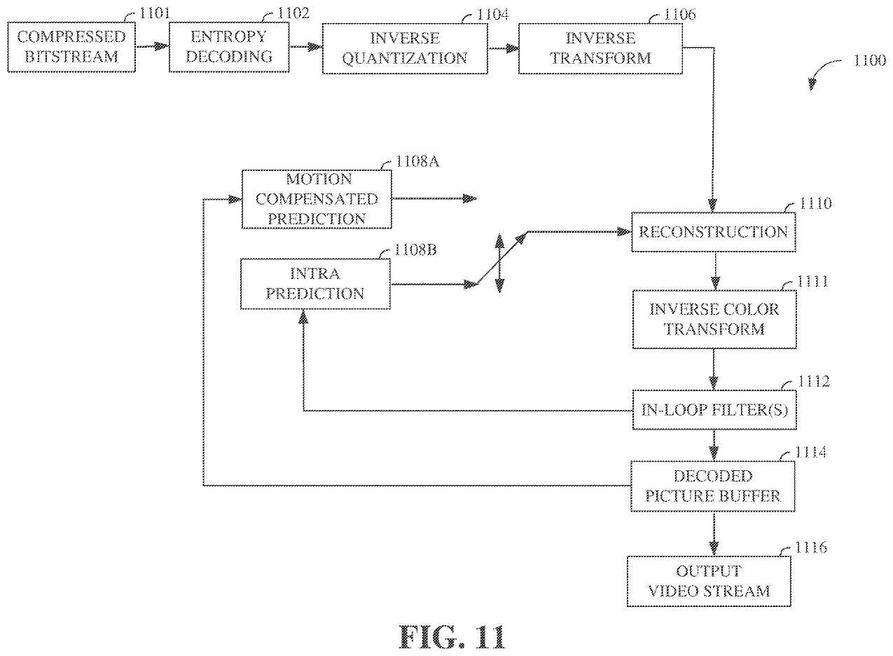

In the examples of FIGS. 9A and 9B, the adaptive transform matrix is not used inside a video or image codec. FIGS. 10 and 11 show examples where the adaptive transform matrix is used inside a video or image codec. First described is FIG. 10, which is a block diagram of an apparatus 1000 for encoding image data using color decorrelation according to the teachings herein. The apparatus 1000 may comprise or include an encoder. In the example of FIG. 10, the apparatus 1000 is similar to the encoder 400. However, this is not required. The apparatus 1000 may include an encoder corresponding to the decoder 600, for example, such that the ACT is applied to residuals.

In general, the apparatus 1000 may implement a method for encoding an image. For example, the method can include applying, to a block of the image, an adaptive transform matrix that converts pixel values of the block from an original color space to a new color space, thereby resulting in color decorrelation of the block. Further, an encoder encodes the block generated in the new color space (e.g., a corresponding residual block of transform coefficients, whether quantized or not) into a compressed bitstream, thereby producing an encoded block of the image. The method can also include transmitting, to a receiving station including a decoder, the compressed bitstream including the encoded block and the color transform information for the encoded block. The color transform information identifies the adaptive transform matrix. Further details of the method and variations in these steps are next described.

An input to the apparatus 1000 is image data that may correspond to an image or a frame. The input to the apparatus 1000 is shown by example as the input video stream 300. Accordingly, the input is a frame in the input video stream 300 (referred to as an image for convenience because only one frame is discussed). The apparatus 1000 applies, to a block of image data, an adaptive transform matrix that converts pixel values of the block from an original color space to a new color space, thereby resulting in color decorrelation of the block. This is performed at a forward color transform stage 1001 of the apparatus 1000.

Various implementations of an adaptive transform matrix may be determined using the input data.

For an unsampled 4:4:4 block, the adaptive transform matrix may be a 3×3 transform matrix. The transform matrix coefficients for the adaptive transform matrix may be determined based on input content so that the correlation among different components in the original color space is removed or reduced. For example, the Karhunen-Loeve transform (KLT) may be used to decorrelate the input video frame or image and to derive the adaptive transform matrix. As the proposed transform matrix is not fixed but is adaptive to input content, it is more efficient than the ACT described with regards to FIG. 6. In some implementations, a number of possible color spaces may be tested to determine which color space to use as the new color space based on which color space minimizes the correlation among the color components, such as different YUV components. These techniques allow for a color transform that can adapt to the input signal efficiently, as opposed to a fixed color transform such as the ACT.

For an input signal comprising a 4:2:0 or 4:2:2 sub-sampled signal, wavelet decomposition may be used together with a color transform. An example using an original color space YUV, a new color space Y′, U′, and V, and a 4:2:0 sub-sampled signal is next described.

In such an input signal, the luma signal Y is 4 times of the chroma signals U and V (i.e., 2× in both vertical and horizontal directions due to the different resolutions of Y, U, and V). The adaptive color transform cannot be applied directly. Following steps may be used to apply the adaptive color transform to such an input signal at the forward color transform stage 1001.

First, wavelet decomposition may be performed on the luma signal Y into four bands. For example, Haar wavelet decomposition may be used to decompose the luma signal Y into low-low (LL), low-high (LH), high-low (HL), and high-high (HH) bands. Each band has the same resolution as the chroma signals U and V. The forward color transform may be performed by applying the adaptive transform matrix to band LL, the chroma signal U, and the chroma signal V. The output comprises the band LL′, the chroma signal U′, and the chroma signal V in the new, second color space. Before the forward color transform, the values of the band LL may be reduced, such as to LL/2 to avoid an overflow error during the forward color transform. Thereafter, an inverse wavelet may be performed to combine the band LL′, LH, HL, and HH to form the luma signal Y′ in the new color space. The output into the prediction process from the forward color transform stage 1001 is thus the luma signal Y′, the chroma signal U′, and the chroma signal V in the new color space.

Similar processing may be used for a 4:2:2 sub-sampled signal as the input signal. In either case, the inverse of these steps may be used to apply the inverse color transform after reconstruction at a decoder as described in additional detail below.

In an alternative implementation, a 4×4 transform matrix or a 6×6 transform matrix may be used for 4:2:2 or 4:2:0 sub-sampled input signals, respectively. A similar example to that described above is used again, that is, where an original color space is YUV, a new color space is Y′, U′, and V, and the input signal is a 4:2:0 sub-sampled signal.

If every other luma pixel of the luma signal Y is taken, four sub-planes Y00, Y01, Y10, and Y11 result. Each has the same resolution as the chroma signals U and V. Then, a 6×6 color transform matrix may be applied to convert [Y00, Y01, Y10, Y11, U, V] to [Y00′, Y01′, Y10′, Y11′, U′, V′]. After the color transform, there are six planes instead of three. The six planes may be grouped into two groups, such as including the first three planes in a first group and the last three planes in a second group. Each group may be coded as unsampled 4:4:4 content. Different coding trees may be applied to the different groups or planes. It is also worth noting that the different planes may have different bit depths.

Cross-plane prediction (similar to CCLM described above) may be allowed among the six planes. If used, prediction should be limited to prediction from planes with a lower index to planes with higher index (e.g., within a coding tree unit or other partitioning).

In these examples, similar processing may be used for a 4:2:2 sub-sampled signal as the input signal. The inverse of these steps may be used to apply the inverse color transform after reconstruction at a decoder as described in additional detail below.

The output of the forward color transform stage in the new color space is encoded. That is, the block in the new color space is encoded by an encoder. In this example, the encoder of the apparatus 1000 includes several stages to perform the various functions in a forward path (shown by the solid connection lines) to produce an encoded or compressed bitstream 1020 using the input video stream 300. An intra/inter prediction stage 1002 operates similarly to the intra/inter prediction stage 402. A transform stage 1004 operates similarly to the transform stage 404. A quantization stage 1006 operates similarly to the quantization stage 406. An entropy encoding stage 1008 operates similarly to the entropy encoding stage 408. Further description is omitted as being duplicative.

The encoder of the apparatus 1000 may also include a reconstruction path (shown by the dotted connection lines) to reconstruct an image or frame for encoding of future blocks. In FIG. 10, the encoder has the following stages to perform the various functions in the reconstruction path: a dequantization (or inverse quantization) stage 1010 that operates similarly to the dequantization stage 410, an inverse transform stage 1012 that operates similarly to the inverse transform stage 412, a reconstruction stage 1014 that operates similarly to the reconstruction stage 414, and a loop filtering stage 1016 that operates similarly to the loop filtering stage 416. Further description of the operation of these stages is omitted as being repetitive.

The encoder of FIG. 10 also differs from the encoder 400 at least in that the encoder of FIG. 10 includes a reverse or inverse color transform stage 1015. As can be seen, the inverse color transform stage 1015 is located after reconstructing the block. That is, after reconstructing the block, and an inverse color transform of the block is performed using the adaptive transform matrix to obtain pixel values for the block in the original color space.

In an example of operation of the forward color transform stage 1001 and the inverse color transform stage 1015, the adaptive transform matrix may be applied at the forward color transform stage 1001 by subtracting a value (e.g., based on the input bit depth of the block or a color component of the block) from at least some color components (such as non-first components) before the transform (e.g., to obtain an adjusted block), and then the value is added back after the transform. An inverse process may be applied at the inverse color transform stage 1015. The bit depths before and after the color transform may be different. In such an example, the values used before and after the color transform may also be different. The values may be transmitted as part of the color transform information. The adaptive color transform can, in some implementations, change the internal bit depth. Further, different bit depths may be used for different color components. The color transform information may include the bit depths in some implementations.

Although the ACT is not used in the encoder of FIG. 10, it could be included as discussed previously, When the ACT discussed with regards to FIG. 6 is included, it may be switched on/off at the block level. For at least this reason, it is desirable to store pixels in a reference buffer for inter prediction in the original domain (i.e., the color space before the color transform). In this way, the application of the ACT may be appropriately applied to the residual block before reconstruction.

As discussed previously, quantization is optional. Accordingly, while the present example includes the quantization stage 1006, the quantization stage 1006 (and correspondingly the inverse quantization stage 1010) may be omitted. In either event, i.e., whether quantized or not, the encoder encodes the residual block of transform coefficients generated in the new color space into the compressed bitstream 1020, thereby producing an encoded block of the image. This process may be repeated for other blocks of the image.

In the encoder shown, performing the inverse color transform at the inverse color transform stage 1015 is done before applying one or more in-loop filters to the block at the loop filtering stage 1016. In other words, the encoder may apply at least one in-loop filtering tool (e.g., in the loop filtering stage 1016) to the pixel values of the block in the original color space. As described above with regards to the encoder 400, this has the goal that the encoder and a corresponding decoder (decoder 500 in the case of the encoder 400) generate the same prediction blocks. The in-loop filters (filtering tools) may include an adaptive loop filter (ALF), a sample adaptive offset (SAO) filter, a deblocking filter, etc., or some combination thereof.

After encoding the block, the compressed bitstream 1020 including the encoded block (e.g., as part of the encoded image or frame) is transmitted to a receiving station, such as the receiving station 106, that includes a decoder.

Color transform information for the encoded block is also transmitted to the receiving station from the apparatus 1000. As described above, the color transform information identifies the adaptive transform matrix for the receiving station. In the example above, the color transform information is an index or values. Signaling the identification of the adaptive transform matrix using the color transform information may be done in other ways.

In some implementations, the color transform information can include the adaptive transform matrix (e.g., the transform matrix coefficients). In some implementations, more than one set of color transformation information may be transmitted (sent, signaled, or otherwise conveyed).

Where, as in FIG. 10, the adaptive transform matrix is used inside the codec, the color transform information may be transmitted in an image, frame, or slice header above the block header. For example, the color transform information may transmit the color transform information in one or more of a sequence parameter set (SPS), a picture parameter set (PPS), an adaptation parameter set (APS), an image header, a slice header, or a coding tree unit (CTU) header. In some implementations where the color transform information is transmitted at the CTU level, the color transform information comprises differentially coded matrix coefficients of the adaptive transform matrix. This results in efficient signaling, as the differences between adjacent CTUs are likely to be small.

In some implementations, the precision of the matrix coefficients of the adaptive transform matrix are predefined. In others, the precision may be transmitted with the color transform information. The precision may be a maximum bit depth of the matrix coefficients, normalization information for determining the matrix coefficients, or both. The precision may be adjusted to better adapt to the input signal and thus may be signaled at different levels in the bitstream.

In the examples above, the input to the forward color transform stage 1001 is [Y U V] in a fixed order. After applying the color transform, the order of the signal may be switched depending upon the transform matrix coefficients. In other words, the output equivalent to the U color component may be the third color component. The inverse color transform stage 1015 would reverse this effect.

Where not all transform matrix coefficients are transmitted as part of the color transform information, either directly or differentially, the color transform information transmitted by the encoder may include information needed to derive those of the transform matrix coefficients. Variations of this implementation are described below with regards to FIG. 11.

FIG. 11 is a block diagram of an apparatus 1100 for decoding image data using color decorrelation according to the teachings herein. The apparatus 1100 may implement the method 800 according to FIG. 8. The apparatus 1100 may comprise the receiving station 106. The apparatus may comprise or include a decoder. In the example of FIG. 11, the apparatus 1100 is similar to the decoder 600 except that the ACT is not available to residuals. The apparatus 1100 may include a decoder corresponding to the decoder 500, for example, or to a decoder corresponding to the decoder 600 including the inverse ACT stage for residuals.

The apparatus 1100 receives a compressed bitstream 1101 generated by an encoder compatible with the decoder of the apparatus, i.e., the encoder produces a decoder-compatible bitstream. The decoder of the apparatus 1100 includes in one example the following stages to perform various functions to produce the output video stream 1116 from the compressed bitstream 1101: an entropy decoding stage 1102 that corresponds to the entropy decoding stage 602, a dequantization or inverse quantization stage 1104 corresponding to the inverse quantization stage 604, an inverse transform stage 1106 corresponding to the inverse transform stage 606, a motion compensated prediction stage 1108A corresponding to the motion compensated prediction stage 608A, an intra prediction stage 1108B corresponding to the intra prediction stage 608B, a reconstruction stage 1110 corresponding to the reconstruction stage 610, an in-loop filtering stage 1112 corresponding to the in-loop filtering stage 612, and a decoded picture buffer stage 1114 corresponding to the decoded picture buffer stage 614. Additional description of these stages is omitted as being duplicative.

Aside from the omission of the inverse ACT stage 607, the decoder of the apparatus 1100 differs from the decoder 600 in that the decoder of the apparatus 1100 includes a backward or inverse color transform stage 1111 that is similar to the inverse color transform stage 1015 of FIG. 10. That is, the adaptive color transform is determined from the color transform information transmitted from the encoder, and after reconstructing the block at the reconstruction stage 1110, an inverse color transform of the block using the adaptive transform matrix to obtain the pixel values for the block in the original color space is performed.

The color transform information transmitted to the apparatus 1100 may be as described with regards to the color transform information of FIG. 10. In some implementations and as mentioned briefly above, the color transform information can include some or all transform matrix coefficients of the adaptive transform matrix.

Where only some transform matrix coefficients are transmitted, one or more constraints may be applied to transform matrices so that some transform matrix coefficients may be derived instead of being signaled/transmitted. For example, a constraint may be applied that requires the total energy of each color component before and after the transform may be unchanged. In other words, the square sum of normalized transform matrix coefficients in a row are equal to one. Under such a constraint, the last transform coefficient of a row is not signaled but may be derived.

In another implementation, sums of non-first rows of an adaptive transform matrix may be zero. Under such a constraint, the last coefficient in signaling order of a row is not signaled but may be derived. Note that the signaling order of a row may be different from the coefficient order in the matrix. The signaling order may be predefined for efficient signaling.

The teachings herein may be described by various implementations and examples, including the following numbered examples.
Example 1: A method for decoding image data, comprising: receiving color transform information for an encoded block of the image data, wherein the color transform information identifies an adaptive transform matrix used to convert a block of the image data from an original color space to a new color space, thereby resulting in color decorrelation of the block before producing the encoded block corresponding to the block; receiving, by a decoder, a compressed bitstream including the encoded block that was encoded using the new color space; reconstructing, by the decoder, the block from the encoded block; determining, from the color transform information, the adaptive transform matrix; after reconstructing the block, performing an inverse color transform of the block using the adaptive transform matrix to obtain pixel values for the block in the original color space; and storing or displaying the image data including the block.
Example 2: The method of Example 1, wherein: reconstructing the block comprises: decoding a residual block of transform coefficients from the compressed bitstream; generating a prediction block corresponding to the residual block; and combining the residual block with the prediction block; and performing the inverse color transform comprises applying the adaptive transform matrix to the block before applying one or more in-loop filters to the block.
Example 3: The method of Example 1, comprising: before storing or displaying the image data including the block, applying at least one in-loop filtering tool to the pixel values in the original color space.
Example 4: The method of Example 3, wherein the at least one in-loop filtering tool comprises at least one of an adaptive loop filter (ALF), a sample adaptive offset (SAO) filter, or a deblocking filter.
Example 5: The method of any of Examples 1 to 4, comprising: storing, within a reference buffer, the pixel values in the original color space for inter prediction.
Example 6: The method of any of Examples 1 to 5, wherein receiving the color transform information comprises receiving an index identifying the adaptive transform matrix from a number of candidate transform matrices.
Example 7: The method of any of Examples 1 to 5, wherein receiving the color transform information comprises receiving the color transform information in one of a sequence parameter set (SPS), a picture parameter set (PPS), an adaptation parameter set (APS), an image header, a slice header, or a coding tree unit (CTU) header.
Example 8: The method of Example 7, comprising: receiving color transform information for multiple encoded blocks of the image data, wherein the encoded block of the image data is a first encoded block, the multiple encoded blocks include a second encoded block of the image data, and the color transform information for the second encoded block of the image data identifies a different adaptive transform matrix than the adaptive transform matrix identified for the first encoded block.
Example 9: The method of any of Examples 1 to 5, wherein the color transform information comprises differentially coded matrix coefficients of the adaptive transform matrix.
Example 10: The method of any of Examples 1 to 9, wherein the color transform information includes a precision of matrix coefficients of the adaptive transform matrix, or the precision of the matrix coefficients is predefined.
Example 11: The method of Example 10, wherein the precision comprises at least one of a maximum bit depth of the matrix coefficients or normalization information for determining the matrix coefficients.
Example 12: The method of any of Examples 1 to 11, wherein the original color space is YUV or RGB.
Example 13: The method of any of Examples 1 to 12, wherein the color transform information includes some transform matrix coefficients of the adaptive transform matrix, and wherein determining the adaptive transform matrix comprises applying a constraint to the adaptive transform matrix to derive others of the transform matrix coefficients of the adaptive transform matrix.
Example 14: The method of Example 13, wherein the constraint requires a total energy of each color component of the original color space and the new color space to be unchanged by the adaptive transform matrix.
Example 15: The method of Example 13, wherein the constraint requires a square sum of normalized transform matrix coefficients in a row of the adaptive transform matrix to be equal to one, the some transform matrix coefficients are included in the color transform information, and the others of the transform matrix coefficients derived include a last coefficient of the row.
Example 16: The method of Example 13, wherein the constraint requires sums of rows of the adaptive transform matrix other than a first row to be equal to zero.
Example 17: The method of Example 16, wherein the some transform matrix coefficients are included in the color transform information, and the others of the transform matrix coefficients derived include a last coefficient of a row.
Example 18: The method of Example 1, wherein performing the inverse color transform comprises applying the adaptive transform matrix in a post-processing step after reconstructing the image.
Example 19: The method of Example 18, wherein receiving the color transform information comprises receiving a supplemental enhancement information (SEI) message including the color transform information.
Example 20: The method of any of Examples 1 to 19, wherein performing the inverse color transform of the block using the adaptive transform matrix to obtain the pixel values comprises: subtracting a first value from at least some color components of the block in the new color space to obtain an adjusted block of values in the new color space; performing the inverse color transform of the adjusted block of values using the adaptive transform matrix; and adding a second value to the at least some color components of the adjusted block in the original color space.
Example 21: The method of Example 20, wherein the first value is equal to the second value.
Example 22: The method of Example 20, wherein the first value and the second value are different.
Example 23: The method of any of Examples 20 to 22, wherein the first value is based on a bit depth before performing the inverse color transform, and the second value is based on a bit depth after performing the inverse color transform.
Example 24: The method of any of Examples 1 to 23, wherein the at least some color components are other than first color components of rows of the block after reconstruction.
Example 25: The method of any of Examples 1 to 24, wherein the adaptive transform matrix changes a bit depth of color of the color components of the block.
Example 26: The method of any of Examples 1 to 25, wherein a bit depth used for the inverse color transform of a first color component of the block is different from a bit depth used for the inverse color transform of a second color component of the block.
Example 27: The method of any of Examples 1 to 25, wherein different bit depths are used for an inverse color transform for different color components of the block.
Example 28: The method of any of Examples 1 to 25, wherein the image data has a 4:4:4 color format, and the adaptive transform matrix comprises a 3×3 transform matrix.
Example 29: An apparatus for decoding an image, comprising: a receiving station including the decoder and configured to perform the method of any of the preceding Examples.
Example 30: A method for encoding image data, comprising: applying, to a block of the image data, an adaptive transform matrix that converts pixel values of the block from an original color space to a new color space, thereby resulting in color decorrelation of the block; encoding, by an encoder, a residual block of transform coefficients generated using the new color space into a compressed bitstream, thereby producing an encoded block of the image data; transmitting, to a receiving station including a decoder, color transform information for the encoded block, wherein the color transform information identifies the adaptive transform matrix; and transmitting, to the receiving station, the compressed bitstream including the encoded block.
Example 31: An apparatus for encoding image data, comprising: a transmitting station including the encoder and configured to perform the method of Example 30.

For simplicity of explanation, the techniques described herein are depicted and described as a series of steps or operations. However, the steps or operations in accordance with this disclosure can occur in various orders and/or concurrently. Additionally, other steps or operations not presented and described herein may be used. Furthermore, not all illustrated steps or operations may be required to implement a method in accordance with the disclosed subject matter.

The aspects of encoding and decoding described above illustrate some examples of encoding and decoding techniques. However, it is to be understood that encoding and decoding, as those terms are used in the claims, could mean compression, decompression, transformation, or any other processing or change of data.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations of the transmitting station 102 and/or the receiving station 106 (and the algorithms, methods, instructions, etc., stored thereon and/or executed thereby, including by the encoder 400 and the decoder 500) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors or any other suitable circuit. In the claims, the term “processor” should be understood as encompassing any of the foregoing hardware, either singly or in combination. The terms “signal” and “data” are used interchangeably. Further, portions of the transmitting station 102 and the receiving station 106 do not necessarily have to be implemented in the same manner.

Further, in one aspect, for example, the transmitting station 102 or the receiving station 106 can be implemented using a general-purpose computer or general-purpose processor with a computer program that, when executed, carries out any of the respective methods, algorithms and/or instructions described herein. In addition, or alternatively, for example, a special purpose computer/processor can be utilized which can contain other hardware for carrying out any of the methods, algorithms, or instructions described herein.

The transmitting station 102 and the receiving station 106 can, for example, be implemented on computers in a video conferencing system. Alternatively, the transmitting station 102 can be implemented on a server and the receiving station 106 can be implemented on a device separate from the server, such as a hand-held communications device. In this instance, the transmitting station 102 can encode content using an encoder 400 into an encoded video signal and transmit the encoded video signal to the communications device. In turn, the communications device can then decode the encoded video signal using a decoder 500. Alternatively, the communications device can decode content stored locally on the communications device, for example, content that was not transmitted by the transmitting station 102. Other suitable transmitting and receiving implementation schemes are available. For example, the receiving station 106 can be a generally stationary personal computer rather than a portable communications device and/or a device including an encoder 400 may also include a decoder 500.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations and aspects have been described to allow easy understanding of the present invention and do not limit the present invention. On the contrary, the invention is intended to cover various modifications and equivalent arrangements included within the scope of the appended claims, which scope is to be accorded the broadest interpretation to encompass all such modifications and equivalent structure as is permitted under the law.

1. A method for decoding image data, comprising:
receiving color transform information for an encoded block of the image data, wherein the color transform information identifies an adaptive transform matrix used to convert an original block of the image data from an original color space to a new color space, thereby resulting in color decorrelation of the original block before producing the encoded block representing the original block;
receiving, by a decoder, a compressed bitstream including the encoded block;
reconstructing, by the decoder, a block from the encoded block;
determining, from the color transform information, the adaptive transform matrix;
after reconstructing the block, performing an inverse color transform of the block using the adaptive transform matrix to obtain pixel values for a reconstructed block in the original color space that corresponds to the original block; and
storing or displaying the image data including the reconstructed block.

2. The method of claim 1, wherein:
reconstructing the block comprises:
decoding a residual block of transform coefficients from the compressed bitstream;
generating a prediction block corresponding to the residual block; and
combining the residual block with the prediction block; and
performing the inverse color transform comprises applying the adaptive transform matrix to the block before applying one or more in-loop filters to obtain the reconstructed block.

3. The method of claim 1, comprising:
before storing or displaying the image data including the reconstructed block, applying at least one in-loop filtering tool to the pixel values in the original color space.

4. The method of claim 1, wherein receiving the color transform information comprises receiving an index identifying the adaptive transform matrix from a number of candidate transform matrices.

5. The method of claim 1, wherein:
receiving the color transform information comprises receiving color transform information for multiple encoded blocks of the image data,
the encoded block of the image data is a first encoded block,
the multiple encoded blocks include a second encoded block of the image data, and
the color transform information for the second encoded block of the image data identifies a different adaptive transform matrix than the adaptive transform matrix identified for the first encoded block.

6. The method of claim 1, wherein the color transform information comprises differentially coded matrix coefficients of the adaptive transform matrix.

7. The method of claim 1, wherein the color transform information includes a precision of matrix coefficients of the adaptive transform matrix, or the precision of the matrix coefficients is predefined, and the precision comprises at least one of a maximum bit depth of the matrix coefficients or normalization information for determining the matrix coefficients.

8. The method of claim 1, wherein:
the adaptive transform matrix comprises transform matrix coefficients,
the color transform information includes some of the transform matrix coefficients of the adaptive transform matrix, and
determining the adaptive transform matrix comprises applying a constraint to the adaptive transform matrix to derive others of the transform matrix coefficients of the adaptive transform matrix.

9. The method of claim 8, wherein the constraint requires a total energy of each color component of the original block in the original color space and in the new color space to be unchanged by the adaptive transform matrix.

10. The method of claim 8, wherein the constraint requires a square sum of normalized transform matrix coefficients in a row of the adaptive transform matrix to be equal to one, the some of the transform matrix coefficients are included in the color transform information, and the others of the transform matrix coefficients derived include a last coefficient of the row.

11. The method of claim 8, wherein the constraint requires sums of rows of the adaptive transform matrix other than a first row to be equal to zero.

12. The method of claim 8, wherein the some of the transform matrix coefficients are included in the color transform information, and the others of the transform matrix coefficients derived include a last coefficient of a row of the transform matrix coefficients.

13. The method of claim 1, wherein performing the inverse color transform comprises applying the adaptive transform matrix in a post-processing step after reconstructing the block.

14. The method of claim 1, wherein performing the inverse color transform of the block using the adaptive transform matrix to obtain the pixel values comprises:
subtracting a first value from at least some color components of the block in the new color space to obtain an adjusted block of values in the new color space;
performing the inverse color transform of the adjusted block of values using the adaptive transform matrix; and
adding a second value to the at least some color components of the adjusted block in the original color space.

15. (canceled)

16. The method of claim 14, wherein the first value is based on a bit depth before performing the inverse color transform, and the second value is based on a bit depth after performing the inverse color transform.

17. (canceled)

18. The method of claim 1, wherein the adaptive transform matrix changes a bit depth of color components of the block to obtain the pixel values for the reconstructed block, and different bit depths are used for performing the inverse color transform for different color components of the block.

19. (canceled)

20. An apparatus for decoding an image, comprising:
a receiving station including the decoder and configured to perform the method of claim 1.

21. A method for encoding image data, comprising:
applying, to an original block of the image data, an adaptive transform matrix that converts pixel values of the original block from an original color space to a new color space, thereby resulting in color decorrelation of the original block;
encoding, by an encoder, a residual block of transform coefficients generated using the new color space into a compressed bitstream, thereby producing an encoded block representing the original block;
transmitting, to a receiving station including a decoder, color transform information for the encoded block, wherein the color transform information identifies the adaptive transform matrix; and
transmitting, to the receiving station, the compressed bitstream including the encoded block.

22. An apparatus for encoding image data, comprising:
a transmitting station including the encoder and configured to perform the method of claim 21.

23. A computer-readable medium storing a compressed bitstream comprising an encoded block of image data, wherein the compressed bitstream comprises color transform information for the encoded block, the color transform information identifies an adaptive transform matrix used to convert an original block of the image data from an original color space to a new color space, thereby resulting in color decorrelation of the original block before producing the encoded block representing the original block, and prediction information for reconstructing a block from the encoded block, and wherein the compressed bitstream is arranged such that a decoder decodes the compressed bitstream by reconstructing the block from the encoded block using the prediction information, determining, from the color transform information, the adaptive transform matrix, and, after reconstructing the block, performing an inverse color transform of the block using the adaptive transform matrix to obtain pixel values for a reconstructed block in the original color space that corresponds to the original block.
